(19) United States
(12) Patent Application Publication
(10) Pub. No.: US 2025/0284014 A1
(43) Pub. Date: Sep. 11, 2025

(54) ACOUSTIC WAVE GENERATOR FOR UNDERWATER APPLICATIONS

(71) Applicant: ENI S.P.A., Roma (IT)

(72) Inventors: Davide CALCAGNI, San Donato Milanese (MI) (IT); Antonio CARCATERRA, Roma (IT); Vittoria FORLEO, San Donato Milanese (IT); Simone BAUDO, San Donato Milanese (MI) (IT)

(73) Assignee: ENI S.P.A., Roma (IT)

(21) Appl. No.: 18/861,472

(22) PCT Filed: Apr. 24, 2023
(86) PCT No.: PCT/IB2023/054184

§ 371 Date: Oct. 29, 2024

(30) Foreign Application Priority Data
Apr. 29, 2022 (IT) 102022000008594

(51) Int. Cl. G01V 1/133

(52) U.S. Cl. CPC G01V 1/133; G01V 2210/1293

(57) ABSTRACT

An acoustic wave generator for underwater applications has a hollow body along an axis, and the hollow body is associated with an acoustic diffuser member. The hollow body houses a first piston and a second piston. A drive group is associated with the first piston to move the first piston towards the second piston. An adjustment unit has a third piston and is interposed between the first and second pistons. The third piston forms a first isolated chamber between the first and third pistons and a second isolated chamber between the third and second pistons. A control unit controls activation of the second piston. A damping unit has an appendage chamber which is associated with the second chamber and is fluid-dynamically isolated therefrom. The pressure of the appendage chamber is controlled by the control unit to modulate the acoustic wave emission spectrum emitted by the diffuser member.

### CROSS-REFERENCE TO RELATED APPLICATIONS

This Patent Application is a national stage application filed under 35 U.S.C. § 371 of PCT Application No. PCT/IB2023/054184, filed Apr. 24, 2023, which claims priority from Italian Patent Application No. 102022000008594 filed on Apr. 29, 2022, the entire disclosure of each of which is incorporated herein by reference.

### BACKGROUND OF THE DISCLOSURE

### 1. Field of the Disclosure

The present disclosure concerns an acoustic wave generator for underwater applications suitable for use in instrumentation for identifying submerged objects and/or for locating oil and/or gas deposits.

The generator comprises a hollow body with a longitudinal axis and with an end associated with an acoustic diffuser member. The hollow body has a rear portion housing a first piston and a front portion housing a second piston. The second piston is capable of freely sliding along the longitudinal axis of the hollow body with a face facing the diffuser member. A drive group is associated to the first piston to move the first piston towards the second piston.

### 2. Description of Related Art

In the field of underwater explorations, it is known to use acoustic or sound waves to map the seabed, classify the potential risks thereof for navigation, identify submerged objects and also to locate oil and gas reserves. In this sector, the reflections of the acoustic waves on the seabed are used to obtain information even for depths reaching beyond 10 km below the seabed. One of the tools used in this type of activity is the so-called “air-guns”, i.e. compressed air guns used to generate acoustic waves whose reflections are processed and analysed in a manner known to the person skilled in the art. These tools are used singly or in multiple arrays and in combination with the so-called “sonars” for acoustic localisation. “Sonar” or echo-sounder is a term that synthesizes a technique used to detect the presence and the position of bodies that are at least partially immersed in “sound navigation and ranging”.

As is known, the underwater world is populated by animals that emit sounds that are detectable through sonars. Among these animals, mention must be made of the cetaceans, mammals that produce acoustic waves of often very high intensity. Cetaceans are sensitive to the emissions of acoustic waves, also produced by human activities.

It is therefore desirable to have an acoustic wave generator that is efficient in producing acoustic waves at the required frequency while respecting the marine environment and the cetaceans living there.

It is also known that acoustic wave generators with particularly high working frequencies are subject to an acoustic saturation that results in a lower efficiency of the acoustic waves produced. In some cases, acoustic saturation is generated by a detachment of the water column from the outer surface of the generator.

The main task of the present disclosure is to solve the technical problems highlighted by overcoming the drawbacks referred to in the aforementioned prior art by devising an acoustic wave generator suitable for use in equipment employable for marine explorations that is effective for such research and safe and reliable in use with respect and safety of the underwater fauna that is found nearby.

### SUMMARY OF THE DISCLOSURE

The idea of the solution underlying the present disclosure is to modulate in a controlled way the frequencies of the acoustic waves produced without thereby reducing the desired characteristics of efficiency of the generator.

Based on this solution idea the technical problem is solved by the acoustic wave generator as described by claim 1.

Further characteristics and advantages are included in the dependent claims.

The characteristics and advantages of an acoustic wave generator according to the present disclosure will result from the description, made hereinafter, by way of non-limiting examples of embodiment with reference to the attached drawings.

### BRIEF DESCRIPTION OF THE DRAWINGS

In such drawings:

FIG. 1 is a schematic longitudinal and side view of an embodiment of an acoustic wave generator according to the present disclosure;

FIG. 2 is a schematic longitudinal and side view of a second embodiment of a portion of a generator made according to the present disclosure; and

FIG. 3 is a schematic side view of an acoustic diffuser member made according to the present disclosure.

### DETAILED DESCRIPTION OF THE DISCLOSURE

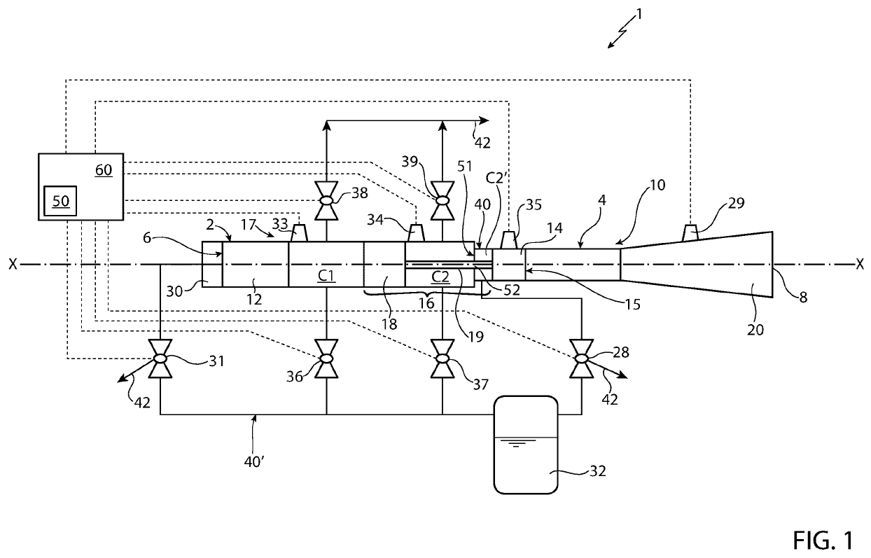

An acoustic wave generator for underwater applications is schematically shown in FIG. 1 and denoted with 1. The generator 1 generates acoustic waves whose spectrum can be defined according to needs and can be validly used in exploratory missions of the seabed and aimed both at mapping the seabed and at discovering new oil and/or gas deposits.

The generator 1 is provided with an elongated hollow body 10 which is developed longitudinally along an axis XX and is delimited by a rear end 6 and by a front end 8 provided with an acoustic diffuser member 20. The hollow body 10 has a first portion 2, substantially cylindrical, which is delimited by the rear end 6 and which is configured to house a first piston 12 or impacting piston. A second portion 4, substantially cylindrical, delimited by the front end 8, is configured to house a second piston 14 or pump piston. The second piston 14 is capable of freely sliding according to the axis XX and is mechanically free from the first piston 12 and has a face 15 facing the acoustic diffuser member 20.

It is considered appropriate to specify that the following description will not describe the fluid-dynamic connection sections connecting valves or other fluid-dynamic components unless their description is required to maximize the understanding of the disclosure. The same approach will be reserved for the electronic connections between components.

The generator 1 comprises a drive group 30 which is associated with the rear end 6 upstream of the first piston 12 and is configured to move the first piston 12 towards the second piston 14 in a sliding manner according to the axis XX.

In one embodiment, the drive group 30 is of the impulsive type. Furthermore, the drive group 30 can be either fluid-dynamically, electrically, or mixedly driven.

The drive group 30 comprises a first three-way drive valve 31, which fluid-dynamically connects the drive group 30 with a tank 32 or with a shared discharge 42. A suitable compressor and a further drive valve, not represented in the figures, can be arranged and coupled to the drive group 30.

The shared discharge 42 is shown in several points in FIG. 1 for economy of design.

The generator 1 comprises a connection unit 16 interposed between the first piston 12 and the second piston 14 for controlling and adjusting, in use, the movements of the second piston 14 with respect to the first piston 12. The connection unit 16 comprises a third piston 18, or hammer piston, also capable of freely sliding according to the axis XX with respect to the first piston 12.

In the hollow body 10 the presence of the third piston 18 results in the formation of a first chamber C1 or insulated air chamber, which is arranged between the first piston 12 and the third piston 18. Furthermore, a second chamber C2 is formed, also isolated, and arranged between the third piston 18 and the second piston 14.

In this way, the first chamber C1 and the second chamber C2 are distinct and in series in the hollow body 10.

The generator 1 further comprises a control unit 60 electronically connected to the connection unit 16 and to the drive group 30 for a controlled activation.

The control unit 60 is provided with a detection unit 50 comprising suitable sensors and detectors that are configured to detect data and information internally and externally to the hollow body 10. The detection unit 50 can be included in the control unit 60 or associated with the control unit 60 but arranged remotely therefrom.

For example, in a non-limiting mode, the detection unit 50 can be arranged in proximity to the acoustic diffuser member 20 to detect the presence of cetaceans in an area surrounding the generator 1 itself.

A damping unit 40 is associated with the second chamber C2 and is driven by the control unit 60 to adjust the pressure in the second chamber C2.

In the embodiment shown in FIG. 1, the damping unit 40 comprises an appendage chamber or auxiliary chamber C2′ interposed between the second chamber C2 and the second piston 14. The appendage or auxiliary chamber C2′ has a cross-section with an area of smaller dimensions than an area of a cross-section of the second chamber C2. The cross-sections are made according to a plane perpendicular to the axis XX.

An intermediate wall 51 is interposed and fluid-dynamically isolates the second chamber C2 from the appendage chamber C2′. The appendage chamber C2′ comprises at least one three-way supply and discharge valve 28, which is connected to the tank 32 and to the discharge 42. The three-way valve 28 is electronically controlled by the control unit 60.

Furthermore, in the embodiment shown, the hollow body 10 has different cross-sections, the cross-section of the first portion 2 has a greater area than the area of the cross-section of the second portion 4. While the second chamber C2 has a cross-section with an area substantially corresponding to the area of the cross-section of the first portion 2. The appendage chamber C2′ has a cross-section with an area substantially corresponding to the area of the cross-section of the second portion 4 that is lower than the area of the cross-section of the first portion 2.

The connection unit 16 comprises a connection member 19 placed between the third piston 18 and the second piston 14 and used to drive the second piston 14. The connection member can comprise a rigid rod 19 which engages the intermediate wall 51 in a hole 52, maintaining the fluid-dynamic insulation between the second chamber C2 and the appendage chamber C2′.

The control unit 16 can also comprise at least one pressure adjuster 17, which, activated by the control unit 60, allows control of the pressure difference between the first chamber C1 and the second chamber C2 i.e. upstream and downstream of the third piston 18.

In one embodiment, the pressure adjuster 17 comprises a first pressure sensor 33 that is associated with the first chamber C1 and a second pressure sensor 34 that is associated with the second chamber C2. Furthermore, a first inlet valve 36 connects the first chamber C1 to the tank 32, and a second inlet valve 37 connects the second chamber C2 to the tank 32. A first discharge valve 38 and a second discharge valve 39, respectively, connect the first chamber C1 and the second chamber C2 to the shared discharge 42. All valves 36, 37, 38, and 39 are electronically connected to the detection unit 50 and are commanded by the control unit 60. A third pressure sensor 35 is associated with the chamber comprising the second piston 14, and a fourth pressure sensor 29 is associated with the acoustic diffuser member 20.

The first sensor 33 and the second sensor 34 as well as the third sensor 35 and the fourth sensor 29 are controlled by the control unit 60, and their signals are sent to the detection unit 50.

As far as the operation is concerned, the acoustic diffuser member 20 emits acoustic waves with a predefined frequency spectrum by means of the operating parameters of the first piston 12, of the second piston 14, and of the interposed adjustment unit 16. In addition, the damping unit 40 more precisely adjusts the predefined frequencies by modulating them even during activation of the first piston 12. In fact, the control unit 60 drives the three-way valve 28 modifying, decreasing, or increasing the pressure of the appendage chamber C2′ allowing to modulate the frequencies of the waves generated by activation of the second piston 14.

Therefore, if the detection unit 50 detects the presence of cetaceans when the first piston 12 is already active, the damping unit 40 allows rapidly modification of the pressure in the appendage chamber C2′ so as to modulate the frequency or the frequency spectrum of the acoustic waves generated by the diffuser member 20.

The operation as a whole can be mathematically synthesized by a transfer function F1 able to describe the longitudinal movement of the second piston 14 in the second portion 4. The longitudinal movement of the second piston 14 is determined through the application of an adequate pressure generated by the drive group 30 on the first piston 12 and on the third piston 18 to suitably move the rod 19.

The transfer function F1 must also describe the action for compressing the fluid contained in the first chamber C1 and in the second chamber C2 and in the appendage or auxiliary chamber C2′. This is in order to emit pressure waves with a frequency spectrum as a function of requirements through the diffuser member 20 and to modulate these frequencies if necessary as a function of the information detected by the detection unit 50.

The transfer function F1 must be completed with the operating parameters of the control unit 16, the adjustment adjuster 17, and the damping unit 40. Furthermore, the operating parameters of the drive valve 31 and of the tank 32 and any additional valves must be considered.

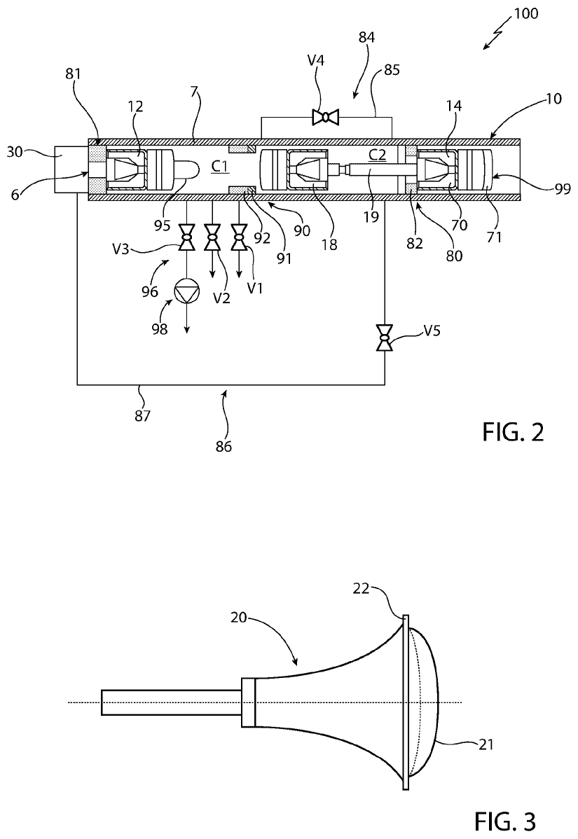

An embodiment shown in FIG. 2 of an acoustic wave generator 100, which is represented partially, will be now described. The parts corresponding in structure and function to those described and shown in FIG. 1 will be indicated with the same reference numbers and abbreviations. Furthermore, if not expressly indicated, each part to be described can be structurally and functionally combined with the parts of the generator 1 shown in FIG. 1.

The generator 100 comprises a locking unit 80, which is configured to generate a braking or holding force. This force allows the second piston 14 to be held in a predefined position or fixed position until an impact is generated by the actuation of the first piston 12 and transmitted by the adjustment unit 16.

The locking unit 80 can be of the mechanical clamp or vice or electrical or electromagnetic type and can have an intensity of the holding force adjustable by the control unit 60.

In the embodiment shown in FIG. 2, the locking unit 80 comprises a first electromagnetic ring 81 associated with the first piston 12 and a second electromagnetic ring 82 associated with the second piston 14.

The first electromagnetic ring 81 is interposed between the first piston 12 and the drive group 30 and is associated with the inner surface of the hollow body 10 in proximity to the rear end 6. The position force generated by the first electromagnetic ring 81 is controlled by the control unit 60 so that the first piston 12 is released only when the pressure difference downstream and upstream of the first piston 12 exceeds a threshold value V1. That is, the first piston 12 remains in the initial position even under the action or reception of a low pressure thrust. This prevents the first piston 12 from gaining speed and moving away under the action of a thrust generated by an undesired propulsive effect. The pressure difference is a value that depends on the pressure generated by the drive group 30 and on the pressure in the first chamber C1 that depends on the possible activation of the pressure adjuster 17. In the shown embodiment, the pressure adjuster 17 comprises three discharge valves V1-V3 arranged in parallel between the first chamber C1 and the shared discharge 42.

The second electromagnetic ring 82 is arranged axially and is associated with the inner surface of the second chamber C2 in proximity to the wall 51. The second electromagnetic ring 82 has the function of holding the second piston 14 in its original position until the instant of the impact due to the thrust of the first piston 12 to the connection member or rod 19 as the sole propulsive effect.

The first and second electromagnetic rings, 81 and 82 of the locking unit 80 allow cancellation of successive axial multiple impacts that might be generated undesirably between the second piston 14 and the first piston 12.

To control the pressure in the first chamber C1 the pressure adjuster 17 also comprises an air extractor 96 provided with a pump 98 connected to one of the three valves V1-V3. The operation of the pump 98 allows the air to be extracted by controlling the pressure difference between the first chamber C1 and the second chamber C2.

In the embodiment, the air extractor 96 can comprise a discharge pipe provided with a wider section that allows avoiding the acoustic choking in the throat of the three valves V1-V3 generated by the saturation of the discharge speed flow. The mounting of a double discharge valve, V1 and V2, allows the air inside the first chamber C1 to be discharged at a lower speed.

Furthermore, it has been found that the presence of the locking unit 80 allows avoiding the detachment of the water column from the outer surface of the hollow body 10 thus improving the efficiency of the generator.

In fact, in the case where the acoustic emission is not caused by the impact of the first piston 12 with the second piston 14 but rather by the sudden stop of the second piston 14 on the abutment surfaces of the hollow body 10, a collapsing cavitation bubble is formed. In this case, the second piston 14 impacts on its stops at high speed producing strong vibrations and stresses in the cylindrical hollow body 10 realizing the phenomenon of acoustic saturation.

Therefore, thanks to the locking unit 80 the effect of the acoustic saturation is reduced or cancelled, allowing a generator 1 that is more efficient and effective in generating acoustic waves than known generators to be obtained.

In one embodiment, a pressure bypass circuit 84 connects the first chamber C1 to the second chamber C2. The bypass circuit 84 comprises a first channel 85 with a bypass valve V4 which is commanded and activated by the control unit 60 and allows reducing the pressure difference between the first chamber C1 and the second chamber C2.

In this way, the pressure at the second chamber C2 in proximity to the second piston 14 is adjusted in relation to the operation of the first piston 12. The force that tends to accelerate the second piston 14 is lower than in the case where the bypass valve V4 is deactivated or absent. The opening of the bypass valve V4 can follow several criteria. Upon activation of the pressure bypass circuit 84, the intensity of the restoring force and/or the holding force of the first electromagnetic ring 81 and of the second electromagnetic ring 82 are modified.

With an increase in pressure in the second chamber C2, when the first piston 12 hits the second piston 14 through the rod 19, the second piston 14 is automatically released since the impact force is much greater than the restoring force of the second electromagnetic ring 82.

A further high pressure bypass circuit 86, which is provided with a second channel 87 and with a pressure reducer V5, connects the second chamber C2 and the drive group 30. In this way, the maintenance of the position of the second piston 14 is ensured by the pressure in the second chamber C2 which can be lowered up to a desired value. As extreme setting, the pressure in the second chamber C2 can be the same pressure generated by the drive group 30.

An end-position 90 can be arranged in the first chamber C1 to stop the first piston 12 after impact with the third piston 18. The end-position 90 comprises a damping element 92 associated with the inner part of the first chamber C1 by means of a support ring 91. The damping element 92 can be an elastic ring or an elastic band with damping function.

In such a case, the first piston 12 can comprise a fuselage-like front point 95 which has the function of allowing the impact between the first piston 12 and the third piston 18 before the first piston 12 stops on the end-position 90.

The second piston 14 can comprise a removable rubber cover or cup 99 associated with the front part in contact with water to mitigate high frequency vibrations.

In one embodiment, the axial rigidity of each piston: first piston 12, second piston 14, or third piston 18, can be reduced by means of respective elastic rings, 70 and 71, interposed between a first and a second piston portion and coupled sequentially. This allows for a reduction in the axial rigidity of the piston with a reduction in acceleration during the impact, mitigating the generation of shock waves and reducing the emission of high frequency signals.

As schematically shown in FIG. 2, the generator 100 can comprise a soft cover 7 configured to externally enclose the hollow body 10 and fixed thereto by means of holding elements, for example, hose clips or the like. In one embodiment, the soft cover 7 is made of spongy material and has a function of attenuating the vibrations suffered by the end-position 90 and transmitted to the structure of the main cylinder or hollow body 10.

An embodiment of the acoustic diffuser member 20 is shown in FIG. 3. The diffuser member 20 has a conical shape with the mouth closed at its distal or front end by a membrane 21. The dashed line shows the stretched membrane 21, while the solid line shows the tensioned membrane 21. A perimeter edge 22 projecting from the cone of the diffuser member 20 is associated with the membrane 21 and allows reducing the flow of water inside the diffuser member 20. Its effect is particularly effective when the generator 100 is towed.

The membrane 21 can be useful for achieving some acoustic effects. In fact, the water trapped in the inner volume of the diffuser member 20 is displaced when the second piston 14 enters the inner volume, and the membrane 21 is tensioned by modifying the generated acoustic wave.

Of course, the transfer function F1 must take into account all the elements and then be completed with the operating parameters and characteristics of the diffuser member 20 and of the membrane 21, of the end-position 90 and of the possible cover 7, of the pressure bypass circuit 84 and of the further high-pressure bypass circuit 86, of the air extractor 96 and of the locking unit 80 that affect the operation of the acoustic wave generator 1.

A suitable transfer function F1 allows control of the activation of the second piston both by means of an a priori control, i.e. before the activation of the first piston, and subsequently with a so-called fine adjustment.

This makes it possible to modulate the acoustic waves based on the information received from the detection unit, allowing an effective generator for seabed research to be obtained, but at the same time allowing reliable and safe in use with respect to the underwater fauna that is found nearby.

1. An acoustic wave generator for underwater applications comprising:
a hollow body developed along an axis and having a front end associated with an acoustic diffuser member,
wherein the hollow body has a rear portion housing a first piston and a front portion housing a second piston,
wherein the second piston can freely slide along the axis and has a face facing the acoustic diffuser member;
a drive group associated with the first piston to move the first piston towards the second piston;
an adjustment unit equipped with a third piston and interposed between the first piston and the second piston,
wherein the third piston forms a first insulated air chamber interposed between the first piston and the third piston and a second insulated air chamber interposed between the third piston and the second piston;
a control unit provided with a detection unit,
wherein the control unit is electronically connected to the adjustment unit to the drive group for a controlled activation of the second piston; and
a damping unit provided with an appendage chamber,
wherein the appendage chamber is associated with the second chamber and is fluid-dynamically insulated from the second chamber, and
wherein the control unit controls a pressure of the appendage chamber to modulate a frequency spectrum of acoustic waves emitted by the acoustic diffuser member.

2. The generator according to claim 1,
wherein the appendage chamber is interposed between the second chamber and the second piston,
wherein the appendage chamber has a cross-section with an area smaller value an area of a cross-section of the second chamber,
wherein the appendage chamber is fluid-dynamically insulated from the second chamber by an interposed intermediate wall, and
wherein the appendage chamber comprises at least one supply/discharge valve controlled by the control unit.

3. The generator according to claim 1, further comprising; at least one locking unit associated with at least the second piston and configured to generate a holding force to hold the second piston in a predefined position until an impact generated by the first piston has a greater intensity than the holding force.

4. The generator according to claim 3,
wherein the locking unit a first electromagnetic ring associated with the second piston and configured to generate the holding force,
wherein the locking unit comprises a second electromagnetic ring associated with the first piston and configured to generate a position force to hold the first piston in a predefined initial position, and
wherein the control unit controls the first electromagnetic ring and the second electromagnetic ring.

5. The generator according to claim 1, further comprising:
(i) a pressure bypass circuit that connects the first chamber to the second chamber,
wherein the pressure bypass circuit is equipped with a bypass valve activated by the control unit to adjust a pressure difference between the first chamber and the second chamber; and/or
(ii) a high-pressure bypass circuit that connects the second chamber to the drive group,
wherein the high-pressure bypass circuit is equipped with a pressure reducer activated by the control unit, and
wherein the generator further comprises an air extractor equipped with a pump connected to the first chamber by one or more extraction valves to create a vacuum.

6. The generator according to claim 1, further comprising; an end-position provided with a damping element associated with an inner wall of the first chamber by a support ring to stop the first piston after an impact with the third piston.

7. The generator according to claim 6, wherein the first piston comprises a front point that allows for the impact between the first piston and the third piston before the first piston stops on the end-position and/or the second piston comprises a removable rubber cup associated with a part of the second piston facing the front end.

8. The generator according to claim 1,
wherein the acoustic diffuser member has a cone of a conical shape with a distal end closed by a membrane, and
wherein the acoustic diffuser member further comprises a peripheral edge that projects from the cone of the acoustic diffuser member and that is associated with the membrane.

9. The generator according to claim 1, wherein the adjustment unit comprises a connection member interposed between the third piston and the second piston.

10. The generator according to claim 1,
wherein the first piston and/or the second piston and/or the third piston comprise at least two parts coupled to one another by means of at least one elastic ring, and/or
wherein the control unit comprises at least one pressure adjuster to adjust a pressure difference between the first chamber and the second chamber.
